(19) United States
(12) Patent Application Publication
(10) Pub. No.: US 2022/0334609 A1
(43) Pub. Date: Oct. 20, 2022

(54) Heterogeneous Timing Closure For Clock-Skew Scheduling or Time Borrowing

(71) Applicant: Intel Corporation, Santa Clara, CA (US)

(72) Inventors: Ilya K. Ganusov, San Jose, CA (US); Grace Zgheib, San Jose, CA (US)

(21) Appl. No.: 17/856,804

(22) Filed: Jul. 1, 2022

(51) Int. Cl. G06F 1/10

(52) U.S. Cl. CPC G06F 1/10

(57) ABSTRACT

Systems or methods for performing clock-skew scheduling or time borrowing using clock delays internal to hardened logic circuitry of an integrated circuit are provided. Such an integrated circuit may include programmable logic circuitry and hardened logic circuitry. The programmable logic circuitry may include at least a first path and a second path. The hardened logic circuitry may include input registers to receive the data from the first path and output registers to output the data to the second path. The hardened logic circuitry may also include first hardened logic circuitry to perform third operations between the input registers and the output registers. The hardened circuitry may also include a first delay circuit configurable to delay a clock signal by a first delay to the input registers or the output registers to enable time borrowing with the hardened logic circuitry.

### BACKGROUND

The present disclosure relates generally to clock-skew scheduling or time borrowing for hardened circuits of an integrated circuit device, such as a field programmable gate array (FPGA).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuit devices may be found in a wide variety of products, including computers, handheld devices, industrial infrastructure, televisions, and vehicles. Programmable integrated circuits (e.g., programmable logic devices (PLDs), field programmable gate arrays (FPGAs)) may include programmable logic circuitry and hardened circuitry (e.g., digital signal processing (DSP) circuits, memory circuits) that may support the programmable logic circuitry with hardened functions. In general, hardened circuitry may include circuitry to perform an operation, such as a mathematical operation like multiplication, more quickly than programmable logic circuitry that has been configured to perform the same operation.

Data may be routed through programmable logic circuitry and hardened circuitry. In a given path through programmable logic circuitry and hardened circuitry, the slowest portion of circuitry between two registers may limit the maximum clock frequency at which a programmable integrated circuit may operate. This is known as the “critical path.” The critical path may be shortened through a process known as “time borrowing” or “cycle stealing,” in which timing slack is taken from programmable logic circuitry of a subsequent or previous path and given to programmable logic circuitry of the critical path. Yet the time to traverse hardened circuitry may be treated as fixed and therefore may not be used for time borrowing in general nor for clock-skew scheduling as a way to perform time borrowing. Accordingly, a critical path through programmable logic circuitry near hardened circuitry may be less susceptible to remedies that could improve the maximum frequency of the integrated circuit.

### BRIEF DESCRIPTION OF THE DRAWINGS

Various aspects of this disclosure may be better understood upon reading the following detailed description and upon reference to the drawings in which:

FIG. 1 is a block diagram of a system for implementing circuit designs on an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of programmable logic circuitry and hardened circuitry of the integrated circuit device of FIG. 1, in accordance with an embodiment of the present disclosure;

FIG. 4 is a block diagram of hardened circuitry of the integrated circuit device of FIG. 1, in accordance with an embodiment of the present disclosure;

FIG. 5 is a block diagram illustrating time-borrowing operations in hardened circuitry of the integrated circuit device of FIG. 1, in accordance with an embodiment of the present disclosure;

FIG. 6 is a block diagram illustrating time-borrowing operations in hardened circuitry of the integrated circuit device of FIG. 1, in accordance with an embodiment of the present disclosure;

FIG. 7 is a flowchart of operations used to improve timing closure of the integrated circuit device of FIG. 1, in accordance with an embodiment of the present disclosure; and

FIG. 8 is a block diagram of a data processing system that includes the integrated circuit device of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Programmable integrated circuits, such as field programmable gate arrays (FPGAs), may be programmed by a user via software such as a version of INTEL® QUARTUS® by INTEL CORPORATION. To program the integrated circuit with the specifications from the user, place and route operations may be utilized to identify hardened portions of circuitry within the FPGA to perform certain operations. Further, programmable logic circuitry, sometimes also referred to as programmable fabric, of the integrated circuit may be programmed to interact with the hardened circuitry to perform the operations specified by the user. Due at least in part to the different speeds at which the programmable fabric and the hardened circuitry may operate, there may be time slack in portions of the hardened circuitry. In other words, in sequential operations where programmable fabric performs operations on data and then passes the data to hardened circuitry to perform further operations on the data, the hardened circuitry may complete its respective operations before the programmable fabric has completed the next round of operations on second data. Time-borrowing techniques may be utilized to reallocate the timing slack in the hardened circuitry to increase operational speed of the FPGA or other programmable integrated circuit.

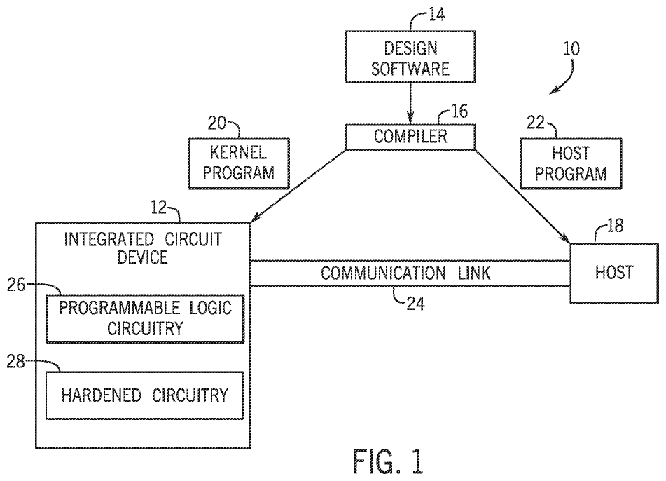

With the foregoing in mind, FIG. 1 illustrates a block diagram of a system 10 that may perform operations as described herein. A designer may desire to implement functionality, such as the operations of this disclosure, or an application involving operations on an integrated circuit device 12 (such as an FPGA). The integrated circuit device 12 may include a single integrated circuit or may include many integrated circuits disposed in a package. The integrated circuit device 12 may implement a programmable system design to carry out the desired functionality. In some cases, the designer may specify a high-level program, such as an OPENCL® program, which may enable the designer to more efficiently and easily provide programming instructions to configure a set of programmable logic cells for the integrated circuit device 12 without requiring specific knowledge of low-level hardware description languages (e.g., Verilog or VHDL). For example, because OPENCL® is quite similar to other high-level programming languages, such as C++, designers of programmable logic familiar with such programming languages may have a reduced learning curve than designers that may have to learn unfamiliar low-level hardware description languages to implement new functionalities in the integrated circuit device 12.

Designers may implement their high-level designs using design software 14, such as a version of INTEL® QUARTUS® by INTEL CORPORATION. The design software 14 may use a compiler 16 to convert the high-level program into a lower-level description. The design software 14 may also be used to optimize and/or increase efficiency in the design. The compiler 16 may provide machine-readable instructions representative of the high-level program to a host 18 and the integrated circuit device 12. The host 18 may receive a host program 22, which may be implemented by kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. The integrated device 12 may include programmable logic circuitry (i.e., “soft” logic) 26 and hardened circuitry 28 to perform operations of the integrated circuit device 12 based on the instructions from the host program 22. The hardened circuitry 28 may have defined operations, and may include DSP blocks, memory blocks (e.g., M20k, M144k, etc.), processors, error correction blocks, crypto blocks, or any other type of hardened circuitry. The design software 14 and/or the compiler 16 may be implemented using any suitable memory and processor (e.g., CPU). For instance, the design software 14 and/or the compiler 16 may be run on the host 18 and/or any other computing devices suitable for executing design and compiling program applications.

The designer may use the design software 14 to generate and/or to specify a low-level program, such as the low-level hardware description languages described above. Further, in some embodiments, the system may be implemented without a separate host program. Moreover, in some embodiments, the techniques described herein may be implemented in circuitry as a non-programmable circuit design. Thus, embodiments described herein are intended to be illustrative and not limiting.

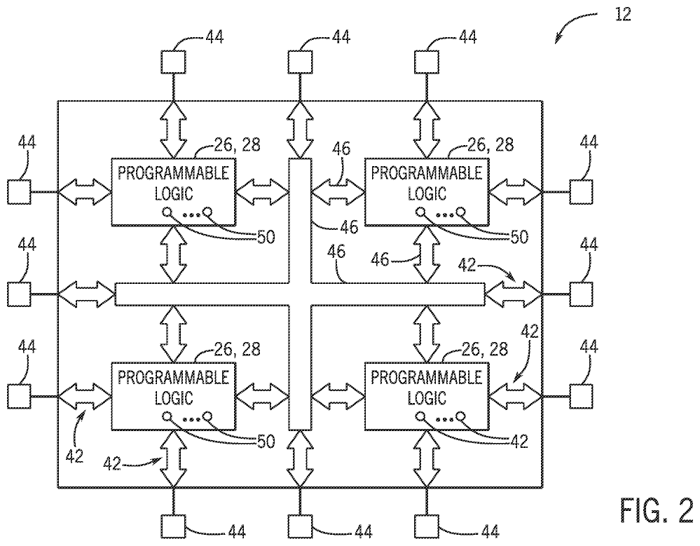

Turning now to a more detailed discussion of the integrated circuit device 12, FIG. 2 illustrates a block diagram of the integrated circuit device 12 that may be a programmable logic device, such as an FPGA. Further, it should be understood that the integrated circuit device 12 may be any other suitable type of programmable logic device (e.g., an application-specific integrated circuit and/or application-specific standard product). Additionally or alternatively, the integrated circuit device 12 may be any suitable integrated circuit device. In certain embodiments, the integrated circuit device 12 may not be a programmable logic device. As shown, the integrated circuit device 12 may have input/output circuitry 42 for driving signals off device and for receiving signals from other devices via input/output pins 44. Interconnection resources 46, such as global and local vertical and horizontal conductive lines and buses, and/or configuration resources (e.g., hardwired couplings, logical couplings not implemented by user logic), may be used to route signals on the integrated circuit device 12. Additionally, interconnection resources 46 may include fixed interconnects (conductive lines) and programmable interconnects (i.e., programmable connections between respective fixed interconnects). Programmable logic circuitry and hardened circuitry 26, 28 may include combinational and sequential logic circuitry. For example, programmable logic circuitry and hardened circuitry 26, 28 may include look-up tables, registers, and multiplexers. In various embodiments, the programmable logic circuitry 26 may be configurable to perform a custom logic function. The programmable interconnects associated with interconnection resources may be considered to be a part of the programmable logic circuitry 26. The programmable logic circuitry 26 may include multiple various types of programmable logic circuitry 26 of different tiers of programmability. For example, the programmable logic circuitry 26 may include various mathematical logic units, such as an arithmetic logic unit (ALU) or configurable logic block (CLB) that may be configurable to perform various mathematical functions (e.g., addition, multiplication, and so forth).

Programmable logic devices, such as integrated circuit device 12, may contain programmable elements 50, such as configuration random-access-memory (CRAM) cells loaded with configuration data during programming and look-up table random-access-memory (LUTRAM) cells that may store either configuration data or user data, within the programmable logic 48. For example, a designer (e.g., a customer) may (re)program (e.g., (re)configure) the programmable logic circuitry 26 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program programmable elements. In general, programmable elements 50 may be based on any suitable programmable technology, such as fuses, antifuses, electrically-programmable read-only-memory technology, random-access memory cells, mask-programmed elements, and so forth.

Further, the hardened circuitry 28 may be dispersed throughout the programmable logic circuitry 26. The hardened circuitry 28 may be used in conjunction with the programmable logic circuitry 26 to perform functions of the integrated circuit device 12. For example, the hardened circuitry 28 may include DSP blocks, crypto blocks, memory blocks such as M20ks, or any other type of hardened circuitry. The hardened circuitry 28 may be used to quickly complete common operations of the integrated circuit device 28 to improve the operational speed and efficiency of the integrated circuit device 12.

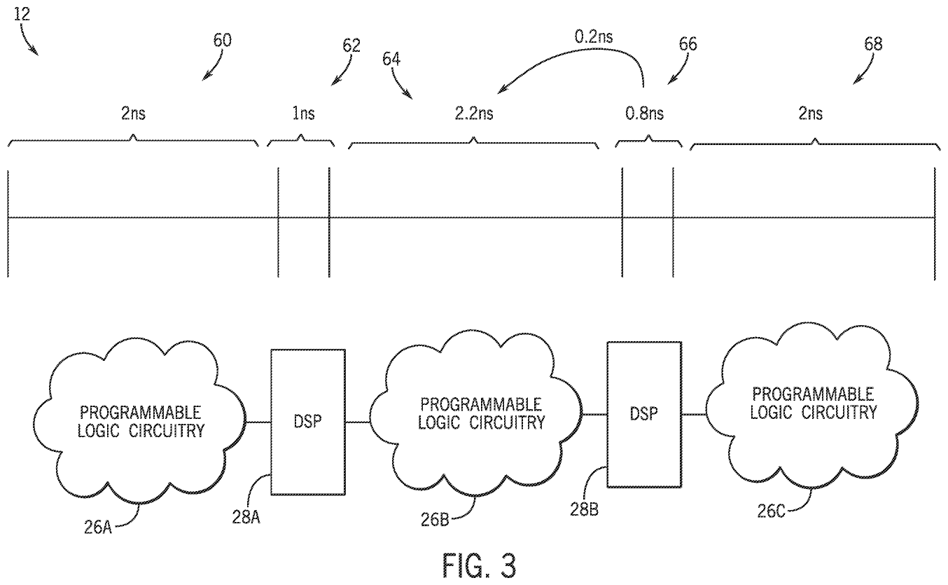

Keeping the forgoing in mind, FIG. 3 illustrates an example showing data paths through the integrated circuit device 12. For example, the integrated circuit device 12 may include a first path through programmable logic circuitry 26A connected to hardened circuitry 28A (shown as a DSP block). The path through the programmable logic circuitry 26A is bounded by registers (not shown). It should be noted that although the hardened circuitry 28A is discussed as being a DSP block, any suitable hardened circuitry may be used, and the example of a DSP block is intended to be illustrative only. In this example, the programmable logic circuitry 26A may perform custom logic functions on data and route results (e.g., partial products) to the DSP block 28A. The DSP block 28A may then perform additional operations on the data, and route the results (e.g., further partial products) to a path through second programmable logic circuitry 26B. Similarly, the programmable logic circuitry 26B may perform operations and route results to a second DSP block 28B. The DSP block 28B may perform operations on the data and route results to a path through third programmable logic circuitry 26C. The third programmable logic circuitry 26C may perform further operations and route the results to other portions of the integrated circuit device 12, such as to a memory device. The results may be routed either directly or via networks-on-chip (NOCs), which may provide rapid communication between portions of the integrated circuit device 12. It should be noted that any pattern of programmable logic circuitry 26 and hardened circuitry 28 may be utilized by the integrated circuit device 12, and that the illustrated example of FIG. 3 is not intended to be limiting.

To ensure accurate operations of the integrated circuit device 12, it may be desirable for the programmable logic circuitries 26A-C and the DSP blocks 28A-B to operate using the same clock. However, due to the differing operational speeds of the circuits (e.g., how long it takes different circuits to complete operations), in some embodiments, the DSP blocks 28A-B may complete their respective operations faster than the programmable logic circuits 26A-C. For example, the programmable logic circuitry 26A may complete its operations within a first time 60 (e.g., 2 nanoseconds (“ns”)). Further, the DSP block 28A may complete its operations within a second time 62 (e.g., 1 ns). The programmable logic circuitry 26B may take a longer amount of time than the programmable logic circuitry 26A and may take a third time 64 (e.g., 2.2 ns) to complete its operations. The DSP block 28B may complete its operations in a time 66, which may be 0.8 ns. Further, the programmable logic circuitry 26C may take a time 68, which may be 2 ns.

The clock signal driving the programmable logic circuitries 26A-C and the DSP blocks A-B may be set according to the slowest programmable logic circuitry 26A-C or DSP block 28A-B. For example, because the programmable logic circuitry 26B has a time 64 of 2.2 ns, the clock for driving the programmable logic circuitries 26A-C and the DSP blocks A-B could be set to a frequency corresponding with a period of 2.2 ns (for example, 0.4545 GHz). To maintain functionality of the integrated circuit device 12, the remaining programmable logic circuitries 26A and 26C, as well as the DSP blocks 28A and 28B, may wait for the next clock cycle before performing further operations once their respective operations for a given clock cycle have been complete. This may lead to an inefficient use of the DSP blocks 28A-B, at least because they have the capacity to operate at least twice as fast as the clock cycle (e.g., the time 62 required for the DSP block 28A to perform its respective operations may be completed with a clock cycle operating at a frequency of 1 GHz).

To regain some of the lost efficiency in the DSP blocks 28A-B, in some embodiments, operations of the DSP blocks 28A-B may be delayed by a programmable amount, employing time-borrowing techniques to enable the use of a faster clock. For example, in some embodiments, the DSP block 28B may be delayed by 0.2 ns. Because the time 66 that it takes for the DSP block 28B to complete its operations on data is 0.8 ns, this delay may cause the DSP block 28B to complete its operations 1 ns after the start of the clock cycle (e.g., 0.2 ns delay+0.8 ns operation time=1 ns until operations are complete). Because the DSP block 28B has slack (time between completion of operations and the start of the next clock cycle) available, this may not interfere with the efficiency of the DSP block 28B. As a result of this delayed start, the programmable logic circuitry 26B may “borrow” the 0.2 ns that the DSP block 28B is delayed by, and the clock cycle may be sped up proportionally. For example, the programmable logic circuitries 26A-C may share the equivalent of an operation time of 2 ns (i.e., the times 60 and 68 may be 2 ns, and the time 64 may “borrow” 0.2 ns from the time 66 to operate as if it were 2 ns.) Accordingly, the clock frequency may be sped up to 0.5 GHz, which may correlate to a period of 2 ns. It should be noted that the time-borrowing techniques described may be for any suitable amount of time slack, and the numbers illustrated are not intended to be limiting. For example, the DSP block 28B (or other circuitry in the integrated circuit device 12) may have a time slack of 0.1 ns, 0.2 ns, 0.3 ns, 0.4 ns, 0.5 ns, 0.6 ns, 0.7 ns, 0.8 ns, 0.9 ns, 1 ns, 2 ns, 3 ns, or any other time.

The process of identifying time slack in the DSP blocks 28A-B and establishing the time delay for the DSP blocks 28A-B (e.g., clock skew scheduling) may be performed as part of the place-and-route operations of the integrated circuit device 12. For example, the place-and-route operations of the integrated circuit device 12 may include programming groups of the programmable logic circuitry 26 (e.g., the programmable logic circuitries 26A-C) to connect with hardened circuitries 28 (e.g., the DSP blocks 28A-B). As part of this process, the slack of the hardened circuitries 28A-B may be utilized to schedule clock delays to the DSPs 28A-B as described above to allow the clock signal to be set at a higher frequency. Additionally or alternatively, establishing the time delay for the DSP blocks 28A-B (e.g., clock skew scheduling) may be performed after place-and-route operations have occurred. For example, establishing the time delay for the DSP blocks 28A-B (e.g., clock skew scheduling) may be performed when sign-off timing is performed to achieve an improved maximum frequency (Fmax) of the system design.

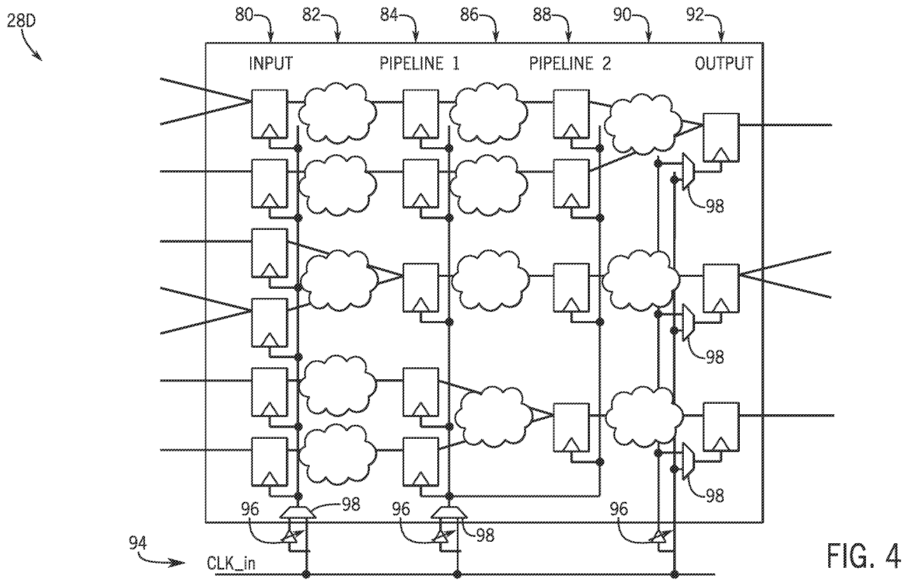

In some embodiments, time slack internal to a single DSP block 28 may be utilized for clock skew scheduling. This is shown by a DSP block 28D of FIG. 4. The DSP block 28D is intended to represent one illustrative example of internal programmable delay circuitry that may be included in any suitable DSP block, or other type of hardened circuitry 28, to enable time borrowing with paths in programmable logic circuitry. The DSP block 28D may include several portions of circuitry. For example, a set of input registers 80 of the DSP block 28D may receive input data, for example from the programmable logic circuitry 26 of the integrated device 12. The set of input registers 80 may route the data to first hardened logic 82. The first hardened logic 82 may perform partial operations on the data, and route the data to a set of pipeline registers 84. The pipeline registers 84 may route the data to second hardened logic 86, which may perform further operations on the data. The data may then be routed to a second set of pipeline registers 88, which may route the data to third hardened logic 90. The third hardened logic 90 may perform final operations on the data, and the results may be routed to a set of output registers 92 to be output from the DSP block 28D.

A clock signal may be sent to the different circuitries and registers of the DSP block 28D to time the operations of the DSP block 28D. For example, each of the sets of registers 80, 84, 88, and 92 and the hardened logic 82, 86, and 90 may perform their respective operations in a single respective clock cycle. Accordingly, it may be possible to identify and utilize time slack from within the DSP block 28D, rather than just from the DSP block 28D as a whole. For example, in some embodiments, employing time-borrowing techniques just on the pipeline registers 80, 84, 88, or 92, for example, may be more efficient than employing such techniques on the DSP block 28D as a whole. This is because hardened logic paths between the pipeline registers 84 within the DSP block 28D may have more positive slack than external soft logic paths through the programmable logic circuitry 26. Moreover, not all hardened circuitry of the DSP block 28D may be used for a particular system design.

Accordingly, to utilize the time slack from within the DSP block 28D, or any hardened circuitry 28, the following may be done. The hardened circuitries 28 with positive time slack may be placed relative to the programmable fabric 26 with longer operational times. Second, the clock signals sent to the respective hardened circuitries 28 may be separated from clock signals going to other portions of the integrated circuit device 12 that are grouped together as described in FIG. 3. Third, delays may be inserted into the clock signals of the hardened circuitries 28 with positive time slack using tunable delay circuits 96 that may be controlled (e.g., programmed) to provide any suitable delay. For example, the clock for all, or a portion (e.g., pipeline registers or input registers), of the hardened circuitries 28 may be delayed. Additionally or alternatively, multiplexers 98 may allow for the original (non-delayed) clock signal to be selected. Although two sets of internal pipeline registers 84 and 88 are shown in FIG. 4 to receive the same clock signal (whether the original clock signal or a delayed version of the clock signal), other examples of the DSP block may include separate delay circuits 96 for different sets of internal pipeline registers.

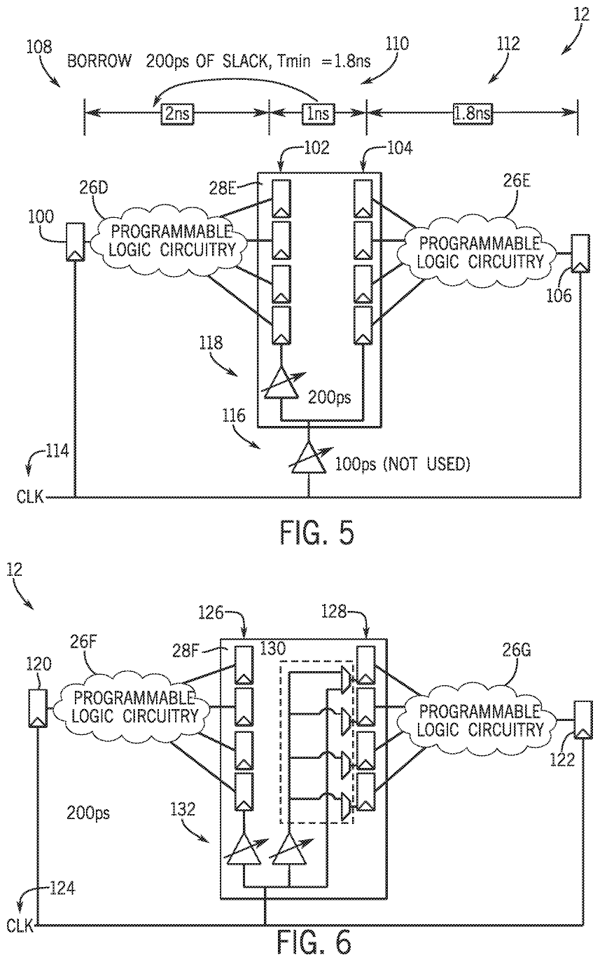

FIG. 5 illustrates an example instance of time-borrowing on the integrated circuit device 12 using the techniques described. For example, the integrated circuit device 12 may include an input register 100 to route data to programmable logic circuitry 26D. The programmable logic circuitry 26D may perform operations on the data and route results of the operations to a DSP block 28E. The DSP block 28E may include input registers 102 and output registers 104, as well as hardened circuitry (not shown) similar to the DSP block 28D described in FIG. 4. The DSP block 28E may perform operations on the data and route the data to programmable logic circuitry 26E via the output registers 104. The programmable logic circuitry 26E may perform operations on the data and output the results to an output register 106. The output register 106 may store the data and route it to other portions of the integrated circuit device 12, such as memory devices or processors of the integrated circuit device 12, either directly or via NOCs.

The programmable logic circuitry 26D may have a time 108 of 2 ns to perform operations on the data. The DSP 28E, at least because of its hardened nature, may complete its operations in a time 110 of 1 ns. Further, the programmable logic circuitry 26E may have a time 112 of 1.8 ns to complete its respective operations on the data. It should be noted that the programmable logic circuitries 26D-E may be different at least in part because their respective operations may vary in complexity, among other things. To time the operations of the integrated circuit device 12, a clock 114 may be sent to the registers 100 and 106, and to the DSP block 28E. As previously described, the clock frequency may be determined by the slowest operating element, for example the programmable logic circuitry 26D. For example, in an embodiment where the clock signal 114 is based off of the time 108 of 2 ns, the clock signal 114 may have a frequency of 0.5 GHz.

In some embodiments, there may be time slack within the DSP block 28E. For example, hardened circuitry between with the input registers 102 and the output registers 104 may have a time slack of at least 0.2 ns. To utilize the time slack of the DSP block 28E, a delay 116 may be applied to the DSP block 28E to stall operations of the DSP block 28E to allow the programmable logic circuitry 26D to complete its operations before the DSP block 28E begins its respective operations. Further, in some embodiments, the DSP block 28E may not, when viewed as a whole, produce enough time slack for the programmable logic circuitry 26D to operate within the time restrains of the clock cycle. Accordingly, a second delay 118 may be sent to an internal portion of the DSP block 28E to utilize the internal slack time therein. For example, the delay 118 may be sent to the input registers 102 to delay their respective operations by a period of time signified by the delay 118 (e.g., 0.2 ns). In this way, the internal slack of the DSP block 28E may be used by the programmable logic circuitry 26D in an example embodiment of a time-borrowing technique.

In some embodiments, the delay 118, or any other delay, may be applied to multiple stages of operations within the DSP block 28E. For example, in some embodiments, it may be desirable to provide more time than any individual stage within the DSP block 28E may provide. Accordingly, the time-borrowing techniques disclosed herein may be staggered throughout the DSP block 28E, or any other hardened circuitry 28, to increase the amount of time slack that the programmable logic circuitry 26D may utilize to increase the frequency of the clock signal 108.

Turning now to FIG. 6, in some embodiments, additional techniques may be utilized to select internal portions of a DSP block 28F to employ the described time-borrowing techniques. For example, in the illustrated example, an input register 120 routes data to programmable logic circuitry 26F, which routes the data to the DSP block 28F. The DSP block 28F may route data to programmable logic circuitry 26G, which in turn may route the data to an output register 122. The operations of the integrated circuit device 12 shown in FIG. 6 may be similar to that illustrated in FIG. 5. Indeed, a clock signal 124 may be sent to the registers 120 and 122 and to the DSP block 28F. As previously described, a clock frequency of the clock signal 124 may be determined by the slowest operating element, for example the programmable logic circuitry 26F.

To more precisely select the internal portions of the DSP block 28F with available time slack to borrow in time-borrowing operations, selection circuitry 130 of the DSP block 28F may include a number of multipliers and other circuitries to identify and target registers or hardened circuitry of the DSP block 28F with time slack available. For example, in some embodiments, the DSP block 28F may include input registers 126 and output registers 128. In some embodiments, different output registers 128 may have more time slack available than others. Accordingly, the selection circuitry 130 may select and registers of the output registers 128 to delay. For example, a delay 132 connected to the clock signal 124 may be applied to the selected registers of the output registers 128. In some embodiments, some or all of the output registers 128 may be selected by the selection circuitry 130 and delayed by the delay 132, or by an individually tailored delay signal (not shown). For example, in some embodiments, a unique delay similar to the delay 132 may be applied to respective registers of the output registers 128.

It should be noted that although the selection circuitry 130 is shown to be associated with the output registers 128, in some embodiments, similar selection circuitries may be associated with any internal portion of the DSP 28F, such as the input registers 126 and any other internal registers or other hardened circuitry, as shown in FIG. 4. However, in some embodiments, delaying the input registers 126 by the delay 132 may stagger-delay later stages of the DSP block 28F. Accordingly, in some embodiments, it may be desirable to select the output registers 128 for time-borrowing techniques, as no other internal circuitry of the DSP block 28F may be affected by the delay 132 applied to the output registers 128.

Further, although the selection circuitry 130 has been described as being internal to the DSP block 28F, in some embodiments, the selection circuitry 130 or other selection circuitries may be located external to the DSP block 28F. Accordingly, there may be any number of selection circuitries 130, and they may be internal to the DSP block 28F, external to the DSP block 28F, or any combination thereof.

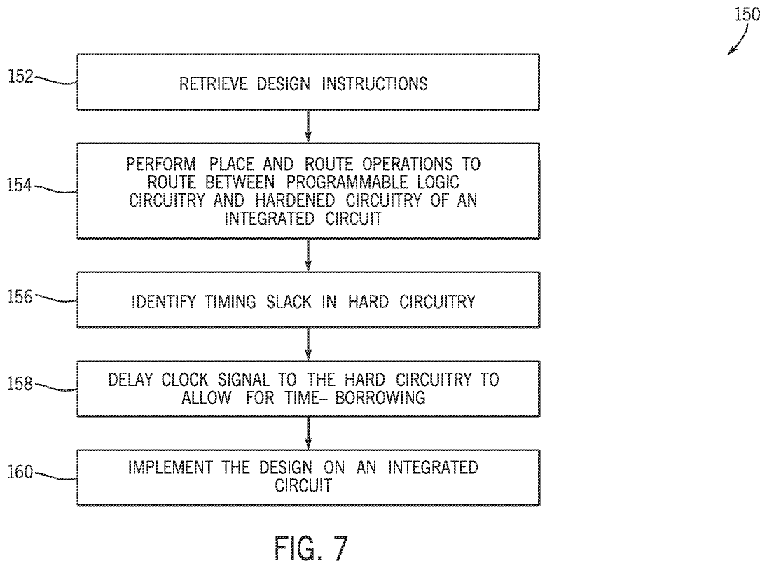

Keeping the foregoing in mind, FIG. 7 illustrates a method 150 of the integrated circuit device 12 to employ the time-borrowing techniques disclosed herein. Accordingly, the integrated circuit device 12 may, in a first action 152, retrieve design instructions. For example, a user may use software such as a version of INTEL® QUARTUS® by INTEL CORPORATION to design instructions for the integrated circuit device 12. As the software design instructions are retrieved by the integrated circuit device 12, the integrated circuit device 12 may, as in action 154, perform place and route operations on hardened circuitry 28 and programmable logic circuitry 26 of the integrated circuit device 12 based on the design instructions. For example, the software may select which hardened circuitries 28 would be best suited for the operations detailed in the design instructions. In an action 156, the software may identify time slack in the hardened circuitry 28. For example, the selection circuitry 130 may be used to select internal portions of the hardened circuitry 28 (e.g., the DSP block 28F) that contain time slack. Further, time slack may be identified from programmable logic circuitry 26 as well. For example, if some programmable logic circuitry 26 completes its respective operations on data relatively quickly, then the time slack from said programmable logic circuitry 26 may be identified for use.

In an action 158, the software may adjust the system design to delay a clock signal to the identified hardened circuitry 28 (or other identified circuitry) to allow for time-borrowing by neighboring circuitries (e.g., programmable logic circuitry 26 with a longer operation time). In some embodiments, this may be accomplished through circuitry (e.g., logic gates configured to delay the arrival of a clock signal to the identified circuitry). After completion of the action 158, the system design may, as in action 160, be implemented on the integrated circuit device 12. It should be noted that the actions indicated in the method 150 are not intended to be exhaustive, and many other operations may be performed to generate the system design to accomplish the time-borrowing techniques described. Further, the actions of the method 150 may generally be exchangeable and may not be limited to the sequential order described. Indeed, in some embodiments, actions of the method 150 may be performed simultaneously.

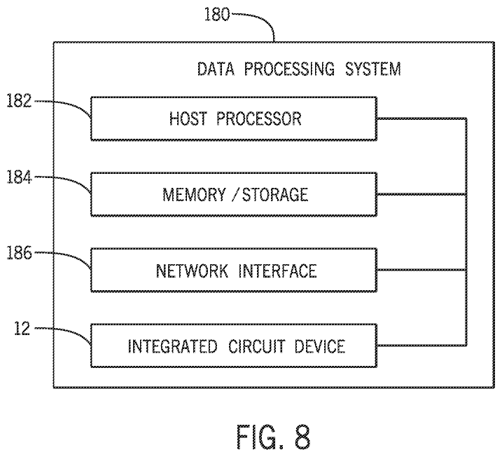

Keeping the foregoing in mind, the integrated circuit device 12 (e.g., integrated circuit device 12A) may be a part of a data processing system or may be a component of a data processing system that may benefit from use of the techniques discussed herein. For example, the integrated circuit device 12 may be a component of a data processing system 180, shown in FIG. 8. The data processing system 180 includes a host processor 182, memory and/or storage circuitry 184, and a network interface 186. The data processing system 180 may include more or fewer components (e.g., electronic display, user interface structures, application specific integrated circuits (ASICs)).

The host processor 182 may include any suitable processor, such as an INTEL® XEON® processor or a reduced-instruction processor (e.g., a reduced instruction set computer (RISC), an Advanced RISC Machine (ARM) processor) that may manage a data processing request for the data processing system 180 (e.g., to perform machine learning, video processing, voice recognition, image recognition, data compression, database search ranking, bioinformatics, network security pattern identification, spatial navigation, or the like). The memory and/or storage circuitry 184 may include random-access memory (RAM), read-only memory (ROM), one or more hard drives, flash memory, or the like. The memory and/or storage circuitry 184 may be considered external memory to the integrated circuit device 12 and may hold data to be processed by the data processing system 180 and/or may be internal to the integrated circuit device 12. In some cases, the memory and/or storage circuitry 184 may also store configuration programs (e.g., bitstream) for programming a programmable fabric of the integrated circuit device 12. The network interface 186 may permit the data processing system 180 to communicate with other electronic devices. The data processing system 180 may include several different packages or may be contained within a single package on a single package substrate.

In one example, the data processing system 180 may be part of a data center that processes a variety of different requests. For instance, the data processing system 180 may receive a data processing request via the network interface 186 to perform machine learning, video processing, voice recognition, image recognition, data compression, database search ranking, bioinformatics, network security pattern identification, spatial navigation, or some other specialized task. The host processor 182 may cause a programmable logic fabric of the integrated circuit device 12 to be programmed with a particular accelerator related to requested task. For instance, the host processor 182 may instruct that configuration data (bitstream) be stored on the memory and/or storage circuitry 184 or cached to be programmed into the programmable logic fabric of the integrated circuit device 12. The configuration data (bitstream) may represent a circuit design for a particular accelerator function relevant to the requested task.

The processes and devices of this disclosure may be incorporated into any suitable circuit. For example, the processes and devices may be incorporated into numerous types of devices such as microprocessors or other integrated circuits. Exemplary integrated circuits include programmable array logic (PAL), programmable logic arrays (PLAs), field programmable logic arrays (FPLAs), electrically programmable logic devices (EPLDs), electrically erasable programmable logic devices (EEPLDs), logic cell arrays (LCAs), field programmable gate arrays (FPGAs), application specific standard products (ASSPs), application specific integrated circuits (ASICs), and microprocessors, just to name a few.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “action for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### EXAMPLE EMBODIMENTS

EXAMPLE EMBODIMENT 1. An integrated circuit comprising:
programmable logic circuitry configurable to include:

a first path to perform first operations on data taking a first amount of time;

a second path to perform second operations on the data taking a second amount of time; and
hardened logic circuitry comprising:

one or more input registers to receive the data from the first path of the programmable logic circuitry;

one or more output registers to output the data to the second path of the programmable logic circuitry;

first hardened logic circuitry to perform third operations on the data taking a third amount of time between the one or more input registers and the one or more output registers; and

a first delay circuit configurable to delay a clock signal by a first delay to the one or more input registers or the one or more output registers to enable time borrowing between the first logic hardened circuitry and the first path of the programmable logic circuitry or the second path of the programmable logic circuitry.

EXAMPLE EMBODIMENT 2. The integrated circuit of example embodiment 1, wherein the hardened logic circuitry comprises selection circuitry configurable to select the clock signal or the clock signal delayed by the first delay to provide to the one or more input registers.

EXAMPLE EMBODIMENT 3. The integrated circuit of example embodiment 1, wherein the hardened logic circuitry comprises selection circuitry configurable to select the clock signal or the clock signal delayed by the first delay to provide to respective registers of the one or more output registers.

EXAMPLE EMBODIMENT 4. The integrated circuit of example embodiment 1, wherein the hardened logic circuitry comprises a second delay circuit configurable to delay the clock signal by a second delay to the other of the one or more input registers or the one or more output registers.

EXAMPLE EMBODIMENT 5. The integrated circuit of example embodiment 4, wherein the first delay is different from the second delay.

EXAMPLE EMBODIMENT 6. The integrated circuit of example embodiment 1, wherein the hardened logic circuit comprises a digital signal processing (DSP) block.

EXAMPLE EMBODIMENT 7. The integrated circuit of example embodiment 1, wherein the hardened logic circuit comprises at least one of a memory block, a processor, an error correction block, or a crypto block.

EXAMPLE EMBODIMENT 8. A digital signal processing (DSP) circuitry of an integrated circuit comprising:
a plurality of input registers to receive data, wherein the plurality of input registers are configurable to be clocked to a clock signal or a first delayed clock signal;

first hardened logic circuitry to perform a first operation on the data;

a plurality of output registers to output the data; and

a first delay circuit configurable to delay the clock signal by a first delay to generate the first delayed clock signal.

EXAMPLE EMBODIMENT 9. The DSP circuitry of example embodiment 8, comprising:
selection circuitry configurable to select whether the plurality of input registers are clocked to the clock signal or to the first delayed clock signal.

EXAMPLE EMBODIMENT 10. The DSP circuitry of example embodiment 8, comprising:
a second delay circuit configurable to delay the clock signal by a second delay to generate a second delayed clock signal;

wherein at least a first of the plurality of output registers is configurable to be clocked to the second delayed clock signal.

EXAMPLE EMBODIMENT 11. The DSP circuitry of example embodiment 10, comprising:
selection circuitry configurable to select whether the first of the plurality of output registers is clocked to the clock signal or to the second delayed clock signal.

EXAMPLE EMBODIMENT 12. The DSP circuitry of example embodiment 10, comprising:

a third delay circuit configurable to delay the clock signal by a third delay to generate a third delayed clock signal;

wherein at least a second of the plurality of output registers is configurable to be clocked to the third delayed clock signal.

EXAMPLE EMBODIMENT 13. The DSP circuitry of example embodiment 8, comprising:
second hardened logic circuitry to perform a second operation on the data; and

a first plurality of pipeline registers between the first hardened logic circuitry and the second hardened logic circuitry.

EXAMPLE EMBODIMENT 14. The DSP circuitry of example embodiment 13, comprising:

a second delay circuit configurable to delay the clock signal by a second delay to generate a second delayed clock signal;

wherein at least a first of the first plurality of pipeline registers is configurable to be clocked to the second delayed clock signal.

EXAMPLE EMBODIMENT 15. The DSP circuitry of example embodiment 14, comprising:
third hardened logic circuitry to perform a second operation on the data; and

a second plurality of pipeline registers between the second hardened logic circuitry and the third hardened logic circuitry.

EXAMPLE EMBODIMENT 16. The DSP circuitry of example embodiment 15, wherein at least a first of the second plurality of pipeline registers is configurable to be clocked to the second delayed clock signal.

EXAMPLE EMBODIMENT 17. The DSP circuitry of example embodiment 14, comprising:

a third delay circuit configurable to delay the clock signal by a third delay to generate a third delayed clock signal;

wherein at least a first of the second plurality of pipeline registers is configurable to be clocked to the third delayed clock signal.

EXAMPLE EMBODIMENT 18. One or more tangible, non-transitory, machine-readable media comprising instructions that, when executed by one or more processors, cause the one or more processors to:
perform place and route operations to route paths of a system design through programmable logic circuitry and hardened circuitry of an integrated circuit;
identify timing slack among the paths; and
provide, to a first set of registers internal to the hardened circuitry but not to a second set of registers internal to the hardened circuitry, a delayed clock signal that is delayed by a first delay to enable time borrowing among at least two of the paths.

EXAMPLE EMBODIMENT 19. The one or more tangible, non-transitory, machine-readable media of example embodiment 18, wherein the timing slack is identified within the hardened circuitry of the integrated circuit and the delayed clock signal is provided to the first set of registers, wherein the first set of registers comprises a set of input registers.

EXAMPLE EMBODIMENT 20. The one or more tangible, non-transitory, machine-readable media of example embodiment 18, wherein the timing slack is identified within the hardened circuitry of the integrated circuit and the delayed clock signal is provided to a third set of registers intermediate between first logic circuitry and second logic circuitry of the hardened circuitry.

What is claimed is:

1. An integrated circuit comprising:
programmable logic circuitry configurable to include:
a first path to perform first operations on data taking a first amount of time;
a second path to perform second operations on the data taking a second amount of time; and
hardened logic circuitry comprising:
one or more input registers to receive the data from the first path of the programmable logic circuitry;
one or more output registers to output the data to the second path of the programmable logic circuitry;
first hardened logic circuitry to perform third operations on the data taking a third amount of time between the one or more input registers and the one or more output registers; and
a first delay circuit configurable to delay a clock signal by a first delay to the one or more input registers or the one or more output registers to enable time borrowing between the first hardened logic circuitry and the first path of the programmable logic circuitry or the second path of the programmable logic circuitry.

2. The integrated circuit of claim 1, wherein the hardened logic circuitry comprises selection circuitry configurable to select the clock signal or the clock signal delayed by the first delay to provide to the one or more input registers.

3. The integrated circuit of claim 1, wherein the hardened logic circuitry comprises selection circuitry configurable to select the clock signal or the clock signal delayed by the first delay to provide to respective registers of the one or more output registers.

4. The integrated circuit of claim 1, wherein the hardened logic circuitry comprises a second delay circuit configurable to delay the clock signal by a second delay to the other of the one or more input registers or the one or more output registers.

5. The integrated circuit of claim 4, wherein the first delay is different from the second delay.

6. The integrated circuit of claim 1, wherein the hardened logic circuit comprises a digital signal processing (DSP) block.

7. The integrated circuit of claim 1, wherein the hardened logic circuit comprises at least one of a memory block, a processor, an error correction block, or a crypto block.

8. A digital signal processing (DSP) circuitry of an integrated circuit comprising:
a plurality of input registers to receive data, wherein the plurality of input registers are configurable to be clocked to a clock signal or a first delayed clock signal;
first hardened logic circuitry to perform a first operation on the data;
a plurality of output registers to output the data; and
a first delay circuit configurable to delay the clock signal by a first delay to generate the first delayed clock signal.

9. The DSP circuitry of claim 8, comprising:
selection circuitry configurable to select whether the plurality of input registers are clocked to the clock signal or to the first delayed clock signal.

10. The DSP circuitry of claim 8, comprising:
a second delay circuit configurable to delay the clock signal by a second delay to generate a second delayed clock signal;
wherein at least a first of the plurality of output registers is configurable to be clocked to the second delayed clock signal.

11. The DSP circuitry of claim 10, comprising:
selection circuitry configurable to select whether the first of the plurality of output registers is clocked to the clock signal or to the second delayed clock signal.

12. The DSP circuitry of claim 10, comprising:
a third delay circuit configurable to delay the clock signal by a third delay to generate a third delayed clock signal;
wherein at least a second of the plurality of output registers is configurable to be clocked to the third delayed clock signal.

13. The DSP circuitry of claim 8, comprising:
second hardened logic circuitry to perform a second operation on the data; and
a first plurality of pipeline registers between the first hardened logic circuitry and the second hardened logic circuitry.

14. The DSP circuitry of claim 13, comprising:
a second delay circuit configurable to delay the clock signal by a second delay to generate a second delayed clock signal;
wherein at least a first of the first plurality of pipeline registers is configurable to be clocked to the second delayed clock signal.

15. The DSP circuitry of claim 14, comprising:
third hardened logic circuitry to perform a second operation on the data; and
a second plurality of pipeline registers between the second hardened logic circuitry and the third hardened logic circuitry.

16. The DSP circuitry of claim 15, wherein at least a first of the second plurality of pipeline registers is configurable to be clocked to the second delayed clock signal.

17. The DSP circuitry of claim 14, comprising:
a third delay circuit configurable to delay the clock signal by a third delay to generate a third delayed clock signal;
wherein at least a first of the second plurality of pipeline registers is configurable to be clocked to the third delayed clock signal.

18. One or more tangible, non-transitory, machine-readable media comprising instructions that, when executed by one or more processors, cause the one or more processors to:
perform place and route operations to route paths of a system design through programmable logic circuitry and hardened circuitry of an integrated circuit;
identify timing slack among the paths; and
provide, to a first set of registers internal to the hardened circuitry but not to a second set of registers internal to the hardened circuitry, a delayed clock signal that is delayed by a first delay to enable time borrowing among at least two of the paths.

19. The one or more tangible, non-transitory, machine-readable media of claim 18, wherein the timing slack is identified within the hardened circuitry of the integrated circuit and the delayed clock signal is provided to the first set of registers, wherein the first set of registers comprises a set of input registers.

20. The one or more tangible, non-transitory, machine-readable media of claim 18, wherein the timing slack is identified within the hardened circuitry of the integrated circuit and the delayed clock signal is provided to a third set of registers intermediate between first logic circuitry and second logic circuitry of the hardened circuitry.
